(19) United States
(12) Patent Application Publication
(10) Pub. No.: US 2006/0283073 A1
(43) Pub. Date: Dec. 21, 2006

(54) Frame for lineguide and fish pole

(75) Inventor: Kazuhito Omura, Shizuoka-shi (JP)

Correspondence Address: OLIFF & BERRIDGE, PLC, P.O. BOX 19928, ALEXANDRIA, VA, 22320, US

(73) Assignee: FUJI KOGYO CO., LTD., Shizuoka-shi (JP)

(21) Appl. No.: 11/448,718

(22) Filed: Jun. 8, 2006

(30) Foreign Application Priority Data
Jun. 9, 2005 (JP) 2005-169463

(51) Int. Cl. A01K 87/04

(52) U.S. Cl. 43/24

(57) ABSTRACT

A line guide frame that includes a plate surface of a side support leg curved in a convex shape outwardly so as to make an arc is provided that allows a shock from a horizontal direction to be and suppress deformation from such a shock In the line guide frame, an edge does not face the outside, so even when the fishing line is tangled in the side support leg and contacts the plate-shaped frame, it does not contact the edge thereby preventing stress on the line.

### BACKGROUND

This invention relates to a line guide frame and a fishing rod.

A fishing line, that passes along the outside of a fishing rod is guided by a line guide format. A conventional line guide frame includes a ring holding portion that holds a guide ring having a through hole for a fishing line (T), a pair of side support legs symmetrically extended to a fishing rod butt side from both right and left sides of the ring holding portion, and an installation leg that is attached to an outer surface of a fishing rod body and joins the pair of side support legs into a single body.

Usually, this type of line guide frame is integrally formed by punching out a plate-shaped metal material by pressing a plate-shaped frame in a desired pattern and further making it to a dimensional shape by bending.

Conventionally, in the ring holding portion, an engaging hole of a guide ring is punched out from a flat plate-shaped member, and a guide ring is pressed into the engaging hole. The guide ring is held by an inner circumferential surface of the engaging hole, i.e., a plate thickness portion of a plate-shaped frame. Recently, a demand for decreased weight, with respect to a line guide frame has increased.

In a response to the demand it has been suggested that, if a line guide frame is integrally formed of a plate-shaped material thinner than a conventional material. However, in such a case the plate thickness becomes thin and the guide ring cannot be reliably held by the plate thick portion only.

Because of this problem, when a thin plate-shaped material is used, as shown in Japanese Laid-Open Patent Application 10-4832, a guide ring is reliably held so as to make the length of the inner circumferential surface of the engaging hole longer than the plate thickness by performing a drawing process over the ring holding portion so as to make a cylindrical shape.

### SUMMARY

However, as described above, normally a line guide frame 31 is integrally formed by a metal plate-shaped material. Therefore, when it is formed to be a cylindrical shape by performing a drawing process over a ring holding portion 33, as shown in FIG. 5, the plate surface of the portion immediately extending from the ring holding portion 33 of a side support leg 35 is unavoidably oriented in a right and left direction, with respect to a fishing rod axis (S). That is, the plate surface 37 must face outside. In this case, as shown in FIG. 7B, the line guide frame 31 is susceptible to a shock to be applied from a horizontal direction and can be easily deformed. For example, if during transport a fishing rod contacts the side of a boat, etc., and this deformation is generated then there is a problem that fishing cannot be continued.

Therefore, in order to suppress deformation, as shown in FIG. 6, reinforcement is proposed which applies a bead 39 over the plate surface 37 of the plate-shaped frame constituting the side support leg 35. However, using the bead 39 makes the appearance unappealing.

Furthermore, flexibility of the metal composition on the side on which the bead 39 is applied deteriorates due to hardening during bead processing. Therefore, if a significant external force is applied, not only can the deformed shape not be returned to the original, but a crack, breakage, etc., occurs. There are also cases that a risk of breaking the plate surface 37 completely off increases.

Regardless of the existence of a bead, as shown in FIG. 8B, an edge 41 of a plate-shaped frame constituting the side support leg 35 faces outside, so when a fishing line (T) contacts the side support leg 35, an additional problem occurs where the fishing line (T) contacts the edge 41 and wear and tear happen which results in the fishing line being easily broken.

Additionally, when the fishing line (T) is tangled in the side support leg 35, a conventional side support leg 35, as shown in FIGS. 5 and 6, forms a very moderate incline falls so as to form a concave arch upwardly toward the installation leg 45 side. Therefore, when tension is applied to the fishing line (T) as shown in FIG. 8B, the fishing line (T) upwardly slips over the flat inclined surface (plate surface) 37 of the side support leg 35 and can easily slip in the upward direction from the top portion of the ring holding portion.

Further, as a result the above-mentioned shape, the entire guide length (g) is extended, so rigidity of a fishing rod at a guide attachment portion is considerably stronger than at other portions of the fishing rod which creates a negative effect on the action in the fishing rod. Furthermore, when the side support legs 35 makes such a concave arch shape, the side support legs 35 in the vicinity of the guide ring abruptly incline as they approach the ring holding portion 33, so even if the tangled fishing line (T) upwardly slips from the lower direction, there was also a negative effect that it easily stops in the vicinity of the ring.

Therefore, an object of this invention is to provide a line guide frame that has a shape designed to decrease weight without sacrificing certain physical characteristics, such as appearance, strength, flexibility, etc. and prevents damage to a fishing line (T), or well as to provide a fishing rod provided with the line guide frame.

In addition to addressing the above-mentioned problem, another object of this invention is to provide a line guide frame having a shape, designed to minimize the negative effect on the fishing rod action, and a fishing rod provided with the line guide frame.

A third object of this invention is to provide a line guide frame having a shape designed to allow fishing line to easily slip, and a fishing rod with the line guide frame.

In order to solve the above-mentioned problem, a line guide frame is provided in which a plate-shaped frame constitutes a ring holding portion that holds a guide ring having a through hole through which a fishing line is inserted in a fishing rod axis direction, an installation leg that is attached to an outer surface of a fishing rod body, and a pair of symmetrical side support legs that extend in a state in which a plate surface is oriented in a right and left direction from right and left sides of the ring holding portion and continues to the installation leg, a plate surface of the side support legs is outwardly curved in a convex shape to form an arc.

In an embodiment of the line guide frame, the side support legs extend from any position from the center axis of the ring holding portion to the top portion so as to form a convexly curved arch and reach the installation leg.

In an embodiment of the line guide frame, the line guide frame is integrally formed of one plate-shaped material, and the ring holding portion is formed to be a cylindrical shape by drawing process.

An embodiment that includes a fishing rod provided with the line guide frame and a fishing rod body on which the line guide frame is mounted is also contemplated.

According to the line guide frame disclosed herein, even if the plate surface of the plate-shaped frame constituting the side support legs faces the outside, the plate surface is outwardly curved in a convex shape to form an arc, so strength can be obtained that can tolerate a shock from a horizontal direction as well.

Additionally, due to the shape of the line guide frame, a fishing line is less likely to contact an edge of a plate-shaped frame constituting a side support leg, so abrasion and cutting of the fishing line can be suppressed.

According to the line guide frame disclosed herein, the plate surface of the plate-shaped frame constituting the side support legs is outwardly curved in a convex shape to form an arc, so when a fishing line is tangled in the side support legs, it does not contact the edge of the plate-shaped frame, and the contact length (c) with the plate surface is decreased and contact resistance is decreased. Thus, even if a fishing line can easily slip on the side support leg and moves toward the installation leg side in a more abrupt inclined manner than a conventional product if a tension is applied, the fishing line smoothly slips over the side support leg and is lifted upward. Therefore, even if the entire length of the guide (g) of the side support leg is made to be shorter than a conventional product, tangling of a fishing line can be suppressed in the same manner as in a conventional product.

Furthermore, as described above, the problem of a fishing line becoming tangled can be resolved. Thus, a so-called protruding shape can be formed, in which the side support legs are extended from or above the center axis of the ring holding portion and form a convex arch in the upper direction or on the fishing rod butt side to the installation leg. As a result, tangling of a fishing line in the vicinity of the ring holding portion of the side support leg can be easily solved, so the fishing line can easily slip through the side support legs.

### BRIEF DESCRIPTION OF THE DRAWINGS

FIG. 1 is a perspective view of a fishing rod related to embodiments of this invention;

FIG. 2 is a top view of a line guide frame of the fishing rod of FIG. 1;

FIG. 3 is a cross-sectional view in a fishing rod axis direction of the fishing rod of FIG. 1;

FIG. 4 is a side view of the fishing rod axis of FIG. 1;

FIG. 5 is a perspective view of a conventional fishing rod;

FIG. 6 is a perspective view of a fishing rod whose fishing rod of FIG. 5 has been modified;

FIGS. 7A and 7B show explanatory views when a shock is applied from a horizontal direction by comparing an embodiment of a line guide frame according to this invention shown in FIG. 7A to a conventional product shown in FIG. 7B; and

FIGS. 8A and 8B show explanatory views when a fishing line (T) is tangled in a side support leg by comparing an embodiment of the invention shown in FIG. 8A to a conventional product shown in FIG. 8B.

### DETAILED DESCRIPTION OF EMBODIMENTS

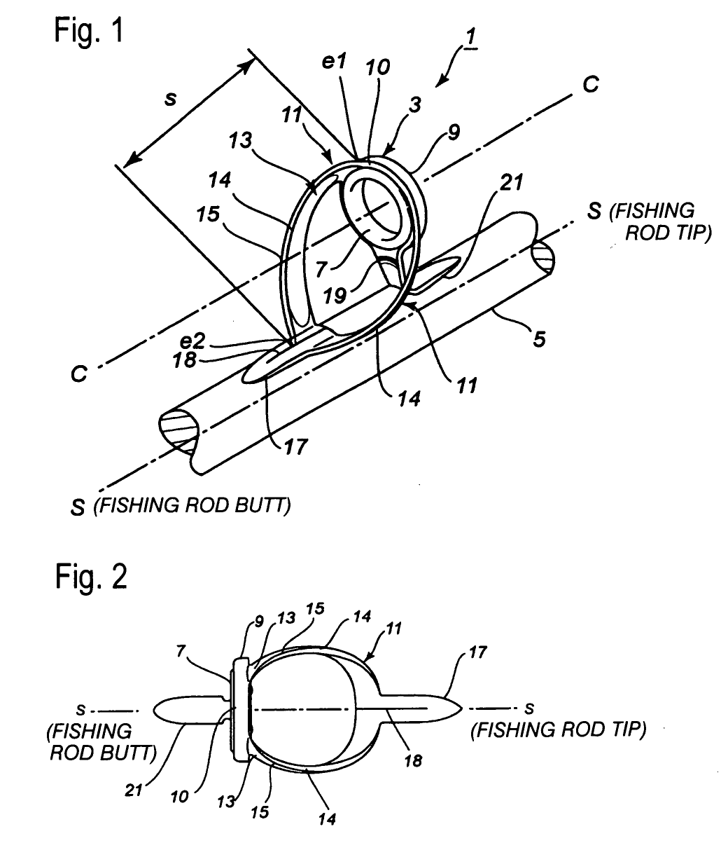

A fishing rod 1 related to embodiments of this invention is explained with reference to the drawings. As shown in FIG. 1, the fishing rod 1 is for an external guide, and a line guide frame 3 is mounted to a fishing rod body 5.

The line guide frame 3 is integrally formed of a metal flat plate-shaped material. First, the material is punched out into a predetermined frame shape by a pressing process and then molded into a predetermined dimensional shape by a drawing process. A round guide ring 7 is formed by a hardened material having abrasion resistance properties, such as a ceramic, or the like.

A drawing process is performed over a ring holding portion 9 before performing a bending process and after the press process so as to make a short cylindrical shape. A cylindrical center axis (C) is oriented parallel to a fishing rod axis (S). A tip end side in the drawing direction faces the fishing rod tip.

The guide ring 7 is engaged to the inner circumferential surface portion of the ring holding portion 9, and is fixed therein via an adhesive (not shown), and is supported on the fishing rod body 5. A through hole of the guide ring 7 is oriented parallel to the fishing rod axis (S) direction.

A pair of side support legs 11, 11 are provided that are symmetrical to each other. As shown in FIGS. 1 and 2 (top views), the side support legs 11, 11 are extended on the fishing rod side to the fishing rod body 5 that is positioned below the right and left sides of the rear end of the ring holding portion 9. The respective tip ends of the side support legs 11, 11 continue to a tongue-shaped installation leg 17 from the right and left sides. The installation leg 17 is formed to have a tapered shape on the fishing rod butt side and contacts the external surface of the ring holding portion 9 side (upper side) of the fishing rod body 5 in a state in which the installation leg 17 is substantially horizontally oriented with respect to the fishing rod axis (S). A crack 18 is formed in the installation leg 17.

As seen from the top view shown in FIG. 2, the pair of side support legs, 11, 11 extend from the rear end of the ring holding portion 9, and then slightly spread in a direction outwardly separated from the fishing rod body 5 up to a middle portion. After changing direction, the side support legs 11, 11 extend in a direction in which the side support legs 11, 11 approach each other toward the fishing rod body 5, and ultimately reach the installation leg 17.

The side support legs 11, 11 extend from the cylindrical rear end forming the ring holding portion 9, and their tip ends reach the installation leg 17. Therefore, the plate surface 13 that matches the orientation direction of the plate surface of the ring holding portion 9, in the vicinity of the ring holding portion 9, is continuously twisted in the middle portion, and matches the orientation direction of the plate surface of the installation leg 17 in the vicinity of the installation leg 17.

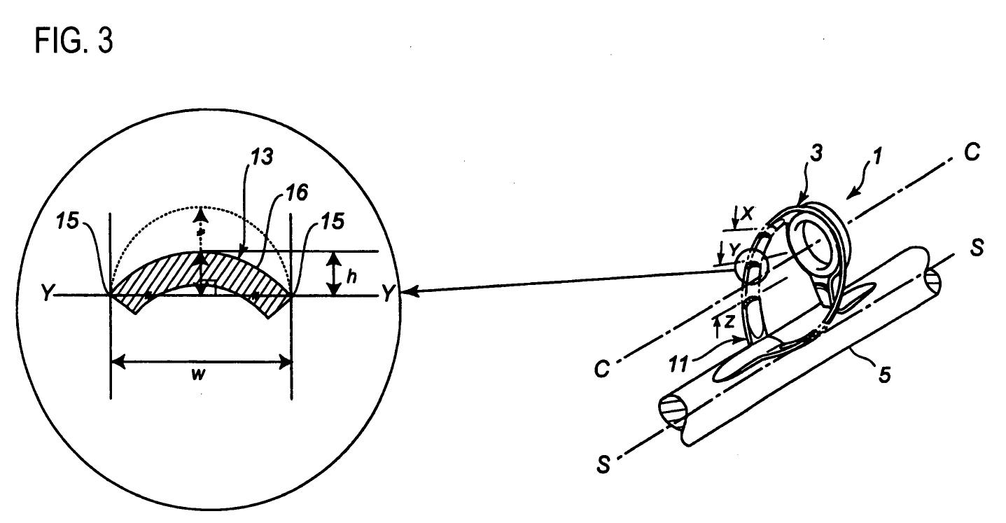

As shown in a cross-sectional view of the side leg support 11 on the left side with respect to the fishing rod axis (S) in FIG. 3, in the X-X cross section in the vicinity of the ring holding portion 9, the plate surface 13 is oriented in the right and left direction. In the middle of the Y-Y cross section, the plate surface 13 is slightly inclined on the up/down direction side. Furthermore, in the Z-Z cross section in the vicinity of the installation leg 17, the plate surface is significantly inclined on the up/down direction side.

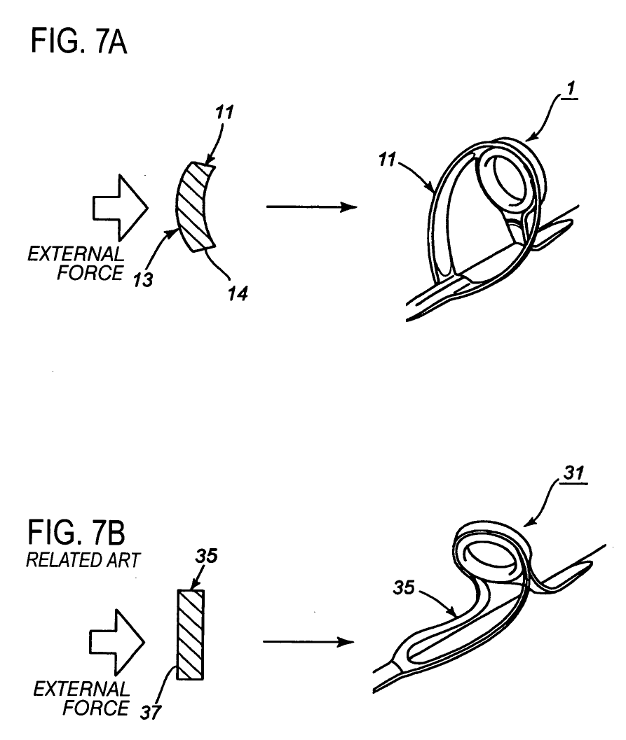

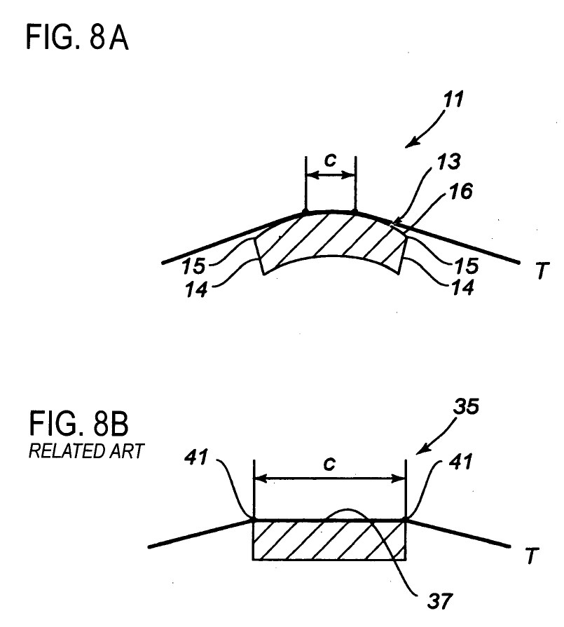

Additionally, the plate-shaped frame constituting the side support leg 11 is outwardly curved in a convex shape and forms an arc. That is, as shown in FIG. 3 (cross-sectional view), the plate surface 13 of the plate-shaped frame constituting the side support leg 11 is outwardly curved and forms an arc in the X-X cross section, the Y-Y cross section, and the Z-Z cross section. Thus, as shown in FIG. 7A, even if a shock is applied in a horizontal direction, the shock can be absorbed so deformation is difficult. Additionally, as shown in FIG. 8A, the edge 15 does not face the outside, so it is possible to suppress the fishing line (T) from contacting the edge 15.

As shown in the cross-sectional view of FIG. 3, in an embodiment, an arc is formed such that (h/w)×100(%)=1˜50%, when a line connecting the edges 15, 15 oriented on both sides in the plate width direction of the plate surface 16 on the curved outside surface is defined as a width (w) and a line vertically dropped from the outermost side surface of the plate surface 16 of the outside to the line (w) is defined as a height (h). The dotted lines of FIG. 3 form an arc in the case of 50%. In an embodiment, an arc is formed such that (h/w)×100(%)=5˜15%.

Furthermore, in all of the above described cross-sectional view, in principle, it is preferable that the arc should be formed at the same percentage, but if it is integrally formed as a plate-shaped frame, due to the restrictions in the processing, immediately after extending from the ring holding portion 9 and immediately before extending to the installation leg 17, it is understood that it is difficult to form an arc.

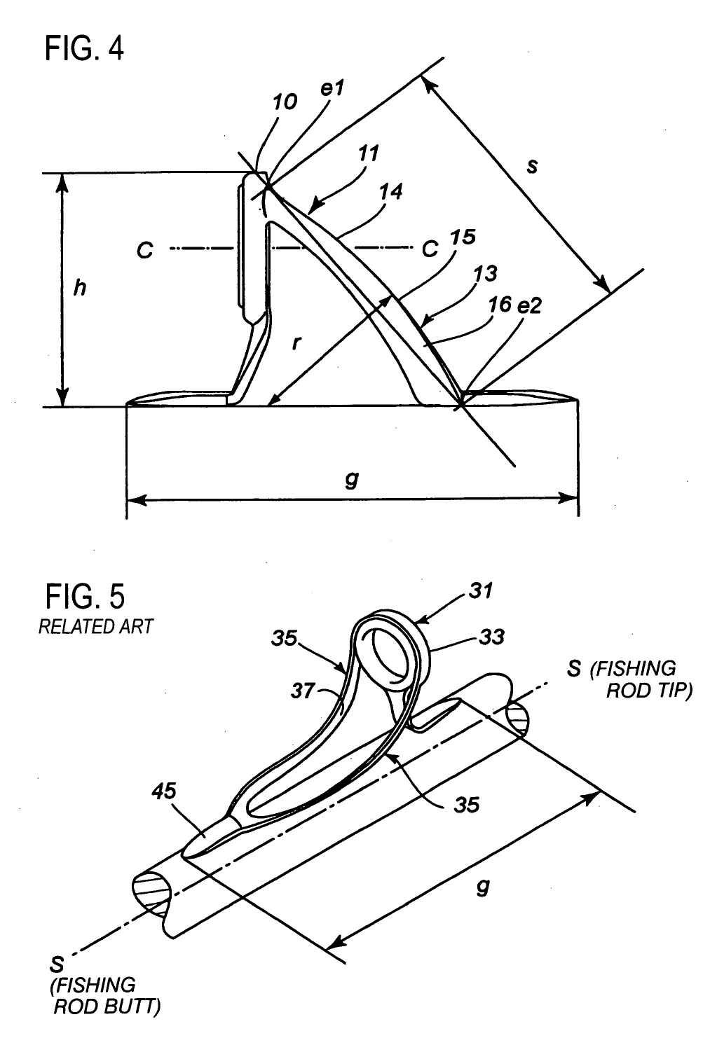

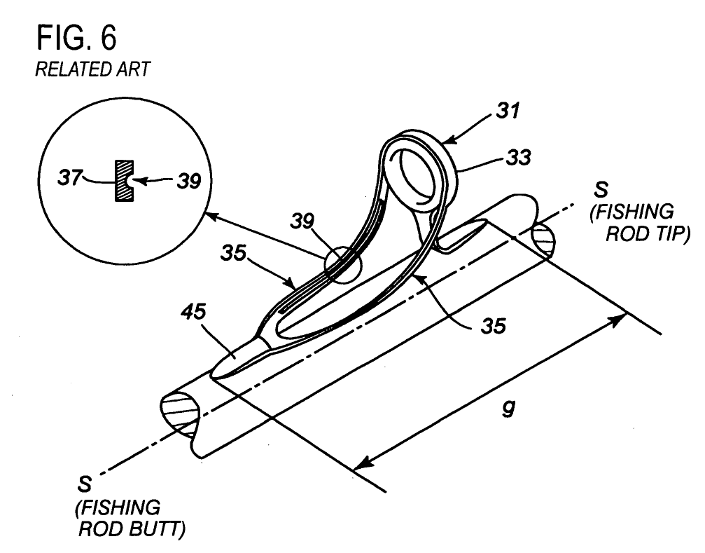

Additionally, as shown in FIG. 4 (side view), the side support legs 11, 11 extend from a position near the top portion 10 from the middle of the center axis (C) of the ring holding portion 9 and the top portion 10, and are moderately curved upwardly and downwardly, and form a convex arch.

By forming a convex arch, the side support legs 11, 11 approach the installation leg 17 in a more abrupt inclined manner than in a conventional product. However, as described above, the edges 15, 15 do not face outside, so when the fishing line (T) is tangled in the side support legs 11, 11, as shown in FIG. 8A, the fishing line (T) does not contact the edges 15 of the plate-shaped frame constituting the side support legs 11. Furthermore, the plate surface 13 is outwardly curved in a convex shape, so the contacting length (c) between the fishing line (T) and the plate surface 13 is short. Therefore, even if the fishing line (T) is tangled and contacts the side support legs, 11, 11, if a tension is applied, the fishing line (T) smoothly moves upwardly on the inclined surface of the side support legs 11, 11 without any contact resistance and is easily pulled out from the top portion of the ring holding portion 9, in contrast to the conventional product shown in FIG. 8B.

Furthermore, in an embodiment the side support legs 11, 11 are extended from a position near the top portion 10 from the middle of the center axis (C) of the ring holding portion 9 and the top portion 10. At the same time, the side support legs 11, 11 can be oriented in a state in which they are extended in a direction separate from the ring holding portion 9. Thus, flexure is not easily generated even if a knot of a thick fishing line, such as a shock leader used for catching a large fish, contacts the ring.

As shown in the perspective view of FIG. 1, and the cross-sectional view of FIG. 4, when the convex arch is extended from the ring holding portion 9, the edge (curved line) 15 positioned above the plate surface 16 outside is considered as an outline of the convex arch, the line connecting the edge point (e1) immediately after extending from the ring holding portion 9 and the edge point (e2) of an imaginary edge line contacting the outside surface of the fishing rod body 5 when going through the installation leg 17 at the same radius of curvature after reaching the installation leg 17 and being extended to the outside surface of the fishing rod body is defined as a string length (s), and the radius of curvature of the edge line 15 is defined as a radius of curvature (r), it is preferable for the radius of curvature (r) of the convex arch and string length (s) to be in the relationship:
r÷(s/2)=1˜3.
r÷(s/2)=1.2˜2.5 is more preferable.

If the radius of curvature (r) is set within the above-mentioned range, the fishing line (T) can be easily pulled out when it is tangled in the side support legs 11, 11. Furthermore, as described above, with respect to the side support legs 11, 11, the drawing is used for the explanation, in which the side support leg 11 on the left side is depicted. However, the side support legs 11, 11 are symmetrical to each other, so it is understood that the side support leg 11 on the right side is arranged in the same manner as the side support leg 11 on the left side.

A front support leg 19 is downwardly extended to the center axis (C) from the rear end of the ring holding portion 9 in an abruptly inclined manner, becomes moderately inclined near the fishing rod body 5 in a reverse direction and continues to a tongue-shaped front installation leg 21.

The front installation leg 21 has a tapered shape on the fishing rod tip side symmetrical to the installation leg 17 and horizontally contacts the fishing rod axis (S) on the outside surface of the ring holding portion 9 side (upper side) of the fishing rod body 5.

With respect to line guide frame 3, as shown in FIG. 1, after the installation leg 17 and the front installation leg 21 contact the external circumferential surface of the fishing rod body 5, a fishing line (not shown) may be wound so as to cover the external circumferential surface of the installation leg 17 and the front installation leg 21, and a hardening resin, etc. applied, and the line guide frame 3 is fixed.

Although embodiments of this invention are explained in reference to the depicted figures, the specific structure of this invention is not limited to the above-mentioned embodiments. Even if design modifications occur within the scope of the claims of this invention, they are included in this invention.

For example, in the above-mentioned embodiments, there is a single installation leg for the side support legs, and the tip end of a pair of side support continues to the installation leg from the both right and left sides. However, it is also acceptable that a pair of installation legs is arranged corresponding to a pair of side support legs and the respective installation legs contact the outside surface of the right and left sides of the fishing rod body.

The front support leg depicted in the above-mentioned embodiments does not need to be arranged. Instead of the front support leg, a pair of side support legs extended to the fishing rod tip side can be arranged. Additionally, the ring holding portion can be supported by only a pair of side support legs extended to the fishing rod butt side.

Furthermore, in the above-mentioned embodiments, the ring holding portion is depicted positioned above the fishing rod body. However, depending on how a user holds the fishing rod body, the ring holding portion may be positioned at the lower or side portion of the fishing rod body. Therefore, it is understood that the position of the ring holding portion with respect to the fishing rod body is not limited to the upper direction shown in the above-mentioned embodiment, but any position within 0-360° may be accepted.

Furthermore, in the above-mentioned embodiments, the ring holding portion is arranged on the fishing rod tip side, and the installation leg is arranged on the fishing rod butt side, but there are cases that they may be arranged the other way around. Therefore, for the convenience of explaining the above-mentioned embodiments, in the above-mentioned embodiments, it is understood the front/back direction and the up/down direction are merely defined corresponding to an attaching state to the fishing rod body of the line guide frame.

Although the line guide frames discussed above are described as being integrally formed by one metal plate-shaped frame by pressing processing, etc. Due to the characteristic shape of the guide frame, other manufacturing methods, for example, casting, stamping, lost wax, MIM, etc., can also be used. Furthermore, the respective parts of the ring holding portion or the like constituting the line guide frame can be formed by two members or more.

What is claimed is:

1. A line guide frame, comprising:
a plate-shaped frame that constitutes a ring holding portion and holds a guide ring, the guide ring having a through hole through which a fishing line is inserted in a fishing rod axis direction;
an installation leg attachable to an outer surface of a fishing rod body, and
a pair of symmetrical side support legs that extend in a state in which a plate surface is oriented in a right and left direction from right and left sides of the ring holding portion and continues to the installation leg,
wherein a the plate surface of the side support legs is outwardly curved in a convex shape to form an arc.

2. The line guide frame as set forth in claim 1,
wherein the side support legs are extended from any position from a center axis of the ring holding portion to a top portion to form a convexly curved arc and reach the installation leg.

3. The line guide frame as set forth in claim 1,
wherein the line guide frame is integrally formed of one plate-shaped material, and the ring holding portion is formed to be a cylindrical shape by drawing process.

4. The line guide frame as set forth in claim 2,
wherein the line guide frame is integrally formed of one plate-shaped material, and the ring holding portion is formed to be a cylindrical shape by drawing process.

5. A fishing rod having a fishing rod body on which a line guide frame is mounted, the line guide comprising:
a plate-shaped frame that constitutes a ring holding portion and holds a guide ring, the guide ring having a through hole through which a fishing line is inserted in a fishing rod axis direction;
an installation leg attachable to an outer surface of a fishing rod body, and
a pair of symmetrical side support legs that extend in a state in which a plate surface is oriented in a right and left direction from right and left sides of the ring holding portion and continues to the installation leg,
wherein a the plate surface of the side support legs is outwardly curved in a convex shape to form an arc.

6. The fishing rod as set forth in claim 5, wherein the side support legs are extended from any position from a center axis of the ring holding portion to a top portion to form a convexly curved arc and reach the installation leg.

7. The fishing rod as set forth in claim 5, wherein the line guide frame is integrally formed of one plate-shaped material, and the ring holding portion is formed to be a cylindrical shape by drawing process.

8. The line guide frame as set forth in claim 6,
wherein the line guide frame is integrally formed of one plate-shaped material, and the ring holding portion is formed to be a cylindrical shape by drawing process.
